(19) United States
(12) Patent Application Publication
(10) Pub. No.: US 2012/0283388 A1
(43) Pub. Date: Nov. 8, 2012

(54) POLYOLEFINS MODIFIED BY SILICONES

(76) Inventors: Michael Backer, Marbais (BE); Thomas Chausse, Thivencelle (FR); Francois De Buyl, Hoeilaart (BE); Damien Deheunynck, Braine L'Alleud (BE); Satoshi Onodera, Chiba (JP); Valerie Smits, Lobbes (BE)

(21) Appl. No.: 13/520,855

(22) PCT Filed: Dec. 22, 2010
(86) PCT No.: PCT/EP10/70480

§ 371 Date: Jul. 6, 2012

(30) Foreign Application Priority Data
Jan. 6, 2010 (GB) GB 1000116.2
Dec. 22, 2010 (EP) PCT/EP2010/070480

(51) Int. Cl. C08F 255/02; C08F 8/00

(52) U.S. Cl. 525/106

(57) ABSTRACT

The invention provides a process for grafting silicone onto a polyolefin comprising reacting the polyolefin with a silicon compound containing an unsaturated group in the presence of means capable of generating free radical sites in the polyolefin, characterized in that the silicon compound is a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C-bond and/or containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C□C-bond. The polyolefin is reinforced by grafting the branched silicone resin onto it.

This invention relates to a process of grafting silicone materials onto polyolefins and to the graft polymers produced, and to compositions comprising a polyolefin and a silicone material.

Polyolefins possess low polarity which is an important benefit for many applications. However, in some instances, the non-polar nature of polyolefins might be a disadvantage and limit their use in a variety of end-uses. For example due to their chemical inertness, functionalisation and crosslinking of polyolefins are difficult. The modification of polyolefin resins by grafting specific compound onto polymer backbone to improve properties is known. U.S. Pat. No. 3,646,155 describes crosslinking of polyolefins, particularly polyethylene, by reaction (grafting) of the polyolefin with an unsaturated hydrolysable silane at a temperature above 140° C. and in the presence of a compound capable of generating free radical sites in the polyolefin. Subsequent exposure of the reaction product to moisture and a silanol condensation catalyst effects crosslinking. This process has been extensively used commercially for crosslinking polyethylene. U.S. Pat. No. 7,041,744 describes such a grafting and crosslinking process. WO2009/073274 I describes grafting other polyolefins and olefin copolymers with an unsaturated hydrolysable silane.

U.S. Pat. No. 5,959,038 describes a thermosetting resin composition comprising a thermosetting organic resin and an organopolysiloxane resin containing acryl- or methacryl-containing organic groups.

An article by Liu, Yao and Huang in Polymer 41, 4537-4542 (2000) entitled ‘Influences of grafting formulations and processing conditions on properties of silane grafted moisture crosslinked polypropylenes’ describes the grafting of polypropylene with unsaturated silanes and the degree of crosslinking (gel percentage) achieved and extent of polypropylene degradation. The unsaturated silanes described are methacryloxypropyltrimethoxysilane and vinyltriethoxysilane. An article by Huang, Lu and Liu in J. Applied Polymer Science 78, 1233-1238 (2000) entitled ‘Influences of grafting formulations and extrusion conditions on properties of silane grafted polypropylenes’ describes a similar grafting process using a twin screw extruder. An article by Lu and Liu in China Plastics Industry, Vol. 27, No. 3, 27-29 (1999) entitled ‘Hydrolytic crosslinking of silane graft onto polypropylene’ is similar. An article by Yang, Song, Zhao, Yang and She in Polymer Engineering and Science, 1004-1008 (2007) entitled ‘Mechanism of a one-step method for preparing silane grafting and crosslinking polypropylene’ describes silane grafting and crosslinking in a one-step method in a twin screw reactive extruder.

WO 00/52073 describes a copolymer of isobutylene with 0.5 to 15 mole percent of a conjugated diene (i.e., a butyl rubber) which is reacted with a silane having both an alkenyl group as well as at least two silicon-bonded hydrolyzable group, the reaction taking place in the presence of a free-radical generator, to provide a modified copolymer having reactive silyl groups grafted thereto.

EP0276790 describes molded articles of polyolefin resin and silicone rubber which are tightly unified to form an integral article can be obtained from a grafted polyolefin resin and silicone rubber. The grafted polyolefin resin is obtained by heat-mixing in the presence of a free-radical initiator a polyolefin resin with a silicon compound having at least one aliphatically unsaturated organic group and at least one silicon-bonded hydrolyzable group.

A composition according to the present invention comprises a thermoplastic polyolefin and a polysiloxane, characterized in that the polysiloxane is a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond and/or containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C≡C— bond.

A process according to the invention for grafting silicone onto a polyolefin comprises reacting the polyolefin with a silicon compound containing an unsaturated group in the presence of means capable of generating free radical sites in the polyolefin, characterized in that the silicon compound is a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond and/or containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C≡C— bond. The polyolefin is reinforced by grafting the branched silicone resin onto it.

The invention includes the use of a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond, X being bonded to the branched silicone resin by a C—Si bond, and R″ represents hydrogen or a group having an electron withdrawing effect or any other activation effect with respect to the —CH═CH— or —C≡C— bond, in grafting silicone moieties to a polyolefin to reinforce the polyolefin. The use of a branched silicone resin containing at least one group of the formula —X—CH═CH—R″ (I) or —X—C≡C—R″ (II) in which X represents a divalent organic linkage having an electron withdrawing effect with respect to the —CH═CH— or —C≡C— bond gives enhanced grafting compared to an unsaturated silicone not containing a —X—CH═CH—R″ or —X—C≡C—R″ group.

The invention also includes the use of a branched silicone resin containing at least one group of the formula —X—CH═CH—R″ (I) or —X—C≡C—R″ (II), in which X represents a divalent organic linkage containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C≡C— bond, in grafting silicone moieties to a polyolefin to reinforce the polyolefin. The use of a branched silicone resin containing at least one group of the formula —X—CH═CH—R″ (I) or —X—C≡C—R″ (II), in which X represents a divalent organic linkage containing an aromatic ring or a further olefinic double bond or acetylenic unsaturation conjugated with the olefinic unsaturation of —X—CH═CH—R″ or with the acetylenic unsaturation of —X—C≡C—R″ achieves grafting with less degradation of the polymer compared to grafting with an unsaturated silicon compound not containing an aromatic ring.

We have found that a silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond, has particularly high grafting efficiency to the polyolefin, readily forming graft polymers in which the polyolefin and the silicone resin are well bonded. The enhanced grafting efficiency can lead to a silane grafted polymer with enhanced physical properties, such as, e.g., mechanical, scratch, impact and heat resistances, flame retardancy properties and adhesion properties.

An electron-withdrawing moiety is a chemical group which draws electrons away from a reaction center. The electron-withdrawing linkage X can in general be any of the groups listed as dienophiles in Michael B. Smith and Jerry March; March's Advanced Organic Chemistry, 5^{th} edition, John Wiley & Sons, New York 2001, at Chapter 15-58 (page 1062). The linkage X can be especially a C(═O)R*, C(═O)OR*, OC(═O)R*, C(═O)Ar linkage in which Ar represents arylene and R* represents a divalent hydrocarbon moiety. X can also be a C(═O)—NH—R* linkage. The electron withdrawing carboxyl, carbonyl, or amide linkage represented by C(═O)R*, C(═O)OR*, OC(═O)R*, C(═O)Ar or C(═O)—NH—R* can be bonded to the branched silicone resin structure by a divalent organic spacer linkage comprising at least one carbon atom separating the C(═O)R*, C(═O)OR*, OC(═O)R*, C(═O)Ar or C(═O)—NH—R* linkage X from the Si atom.

Electron-donating groups, for example alcohol group or amino group may decrease the electron withdrawing effect. In one embodiment, the branched silicone resin is free of such group. Steric effects for example steric hindrance of a terminal alkyl group such as methyl, may affect the reactivity of the olefinic or acetylenic bond. In one embodiment, the branched silicone resin is free of such sterically hindering group. Groups enhancing the stability of the radical formed during the grafting reaction, for example double bond or aromatic group conjugated with the unsaturation of the group —X—CH═CH—R″ (I) or X—C≡C—R″ (II), are preferably present in (I) or (II). The latter groups have an activation effect with respect to the —CH═CH— or —C≡C— bond.

Silane grafting, for example as described in the above listed patents is efficient to functionalize and crosslink polyethylenes. However when trying to functionalize polypropylene using the above technologies, the grafting is accompanied by degradation of the polymer by chain scission in the β-position or so-called β-scission. We have found that a silicone resin containing at least one group of the formula:

—X—CH═CH—R″ (I) or

—X—C≡C—R″ (II);

in which X represents a divalent organic linkage containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, grafts efficiently to polypropylene, and to other polyolefins comprising at least 50% by weight units of an alpha-olefin having 3 to 8 carbon atoms, with minimised degradation by β-scission.

A silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond, but not containing an aromatic ring or a further olefinic double bond or acetylenic unsaturation, can be grafted efficiently to polypropylene, and to other polyolefins comprising at least 50% by weight units of an alpha-olefin having 3 to 8 carbon atoms, if the silicone resin is combined with an appropriate co-agent as described below.

Polyorganosiloxanes, also known as silicones, generally comprise siloxane units selected from R₃SiO_{1/2} (M units), R₂SiO_{2/2} (D units), RSiO_{3/2} (T units) and SiO_{4/2} (Q units), in which each R represents an organic group or hydrogen or a hydroxyl group. Branched silicone resins contain T and/or Q units, optionally in combination with M and/or D units. In the branched silicone resins used in the present invention, no more than 50 mole % of the siloxane units in the resin are D units.

Branched silicone resins can for example be prepared by the hydrolysis and condensation of hydrolysable silanes such as alkoxysilanes. Trialkoxysilanes such as alkyltrialkoxysilanes generally lead to T units in the silicone resin and tetraalkoxysilanes generally lead to Q units. Branched silicone resins containing at least one group of the formula —X—CH═CH—R″ (I) or —X—C≡C—R″ (II) can for example be formed by condensing trialkoxysilanes of the formula (R′O)₃Si—X—CH═CH—R″ or (R′O)₃Si—X—C≡C—R″, in which X and R″ have the meanings above and R′ represents an alkyl group, preferably methyl or ethyl, alone or with other alkoxysilanes. Alternatively a branched silicone resin can be produced from monoalkoxysilanes or dialkoxysilanes containing a group of the formula —X—CH═CH—R″ or —X—C≡C—R″ by co-condensation with a trialkoxysilane or tetraalkoxysilane not containing a group of the formula —X—CH═CH—R″ or —X—C≡C—R″. Condensation is catalysed by acids or bases. A strong acid catalyst such as trifluoromethanesulfonic acid or hydrochloric acid is preferred.

The branched silicone resins containing at least one group of the formula —X—CH═CH—R″ (I) or —X—C≡C—R″ (II) can alternatively be prepared from an existing branched silicone resin containing Si—OH and/or Si-bonded alkoxy groups by an end-capping reaction with an alkoxysilane containing a group of the formula —X—CH═CH—R″ or —X—C≡C—R″. The end-capping reaction is a condensation reaction between the Si—OH or Si-alkoxy group of the branched silicone resin and a Si-alkoxy group of the silane. The existing branched silicone resin can for example be a T resin or MQ resin containing Si—OH and/or Si-bonded alkoxy groups. The alkoxysilane can be a monoalkoxysilane, dialkoxysilane or trialkoxysilane and may preferably be a trialkoxysilane of the formula (R′O)₃Si—X—CH═CH—R″ or (R′O)₃Si—X—C≡C—R″, in which X and R″ have the meanings above and R′ represents an alkyl group, preferably methyl or ethyl. The end-capping condensation reaction is catalysed by acids or bases as discussed above.

Examples of groups of the formula —X—CH═CH—R″ (I) in which X represents a divalent organic linkage having an electron withdrawing effect with respect to the —CH═CH-bond include acryloxy groups such as 3-acryloxypropyl or acryloxymethyl. Such groups can be introduced into a branched silicone resin by reaction of 3-acryloxypropyltrimethoxysilane or acryloxymethyltrimethoxysilane. 3-acryloxypropyltrimethoxysilane can be prepared from allyl acrylate and trimethoxysilane by the process described in U.S. Pat. No. 3,179,612. Acryloxymethyltrimethoxysilane can be prepared from acrylic acid and chloromethyltrimethoxysilane by the process described in U.S. Pat. No. 3,179,612. Branched silicone resins containing acryloxy groups, and their preparation, are described for example in WO-A-2006/019468 and in EP-A-776945. We have found that silicone resins containing acryloxyalkyl groups graft to polyolefins more readily than silicone compounds containing methacryloxyalkyl groups.

By an aromatic ring we mean any cyclic moiety which is unsaturated and which shows some aromatic character or π-bonding. The aromatic ring can be a carbocyclic ring such as a benzene or cyclopentadiene ring or a heterocyclic ring such as a furan, thiophene, pyrrole or pyridine ring, and can be a single ring or a fused ring system such as a naphthalene, quinoline or indole moiety.

Examples of groups of the formula —X—CH═CH—R″ (I) or —X—C≡C—R″ in which X represents a divalent organic linkage containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″ include those of the formula CH₂═CH—C₆H₄-A- or CH≡C—C₆H₄-A-, wherein A represents a direct bond or a spacer group. The group —X—CH═CH—R″ (I) can for example be styryl (C6H5CH═CH— or —C6H4CH═CH2), styrylmethyl, 2-styrylethyl or 3-styrylpropyl. Such groups can be introduced into a branched silicone resin by reaction of for example 4-(trimethoxysilyl)styrene or styrylethyl trimethoxysilane. 4-(trimethoxysilyl)styrene can be prepared via the Grignard reaction of 4-bromo- and/or 4-chlorostyrene with tetramethoxysilane in the presence of magnesium as described in EP-B-1318153. Styrylethyltrimethoxysilane is e.g. commercially available from Gelest, Inc as a mixture of meta and para, as well as alpha, and beta isomers. The spacer group A can optionally comprise a heteroatom linking group particularly an oxygen, sulfur or nitrogen heteroatom, for example the group —X—CH═CH—R″ (I) can be vinylphenylmethylthiopropyl.

Examples of groups of the formula —X—CH═CH—R″ (I) in which X represents a divalent organic linkage having an electron withdrawing effect with respect to the —CH═CH-bond and also containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″ include sorbyloxyalkyl groups such as sorbyloxypropyl CH₃—CH═CH—CH═CH—C(═O)O—(CH₂)₃— derived from condensation of a trialkoxysilane such as

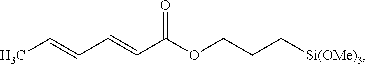

cinnamyloxyalkyl groups such as cinnamyloxypropyl derived from condensation of a trialkoxysilane such as

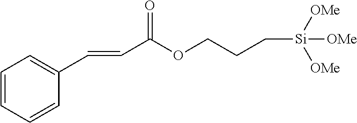

whose preparation is described in U.S. Pat. No. 3,179,612, or 3-(2-furyl)acryloxyalkyl groups such as 3-(2-furyl)acryloxypropyl derived from condensation of a trialkoxysilane such as

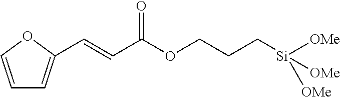

The branched silicone resin can for example be a T resin in which at least 50 mole %, and preferably at least 75% or even 90%, of the siloxane units present in the branched silicone resin are T units. Such a resin can be formed by condensation of one or more trialkoxysilane, optionally with minor amounts of tetraalkoxysilane, dialkoxysilane and/or monoalkoxysilane. In general, 0.1 to 100 mole % of the siloxane T units present in such a branched silicone resin are of the formula R″—CH═CH—X—SiO_{3/2}.

Other organic groups present in the branched silicone resin can in general be alkyl, substituted alkyl, alkenyl, substituted alkenyl, aryl, substituted aryl or aralkyl groups or heterocyclic groups bonded to the branched silicone resin by a C—Si bond, but are most usually alkyl, particularly C₁₋₄ alkyl such as methyl, ethyl or propyl, or vinyl or phenyl.

The T-resin can have a cage-like structure. Such structures containing 100% T units are known as polyhedral oligomeric silsesquioxanes (POSS). They can be prepared by condensing trialkoxysilanes of the formula (R′O)₃Si—X—CH═CH—R″ or (R′O)₃Si—X—C≡C—R″ alone or in combination with other trialkoxysilanes having aryl and alkyl, particularly methyl, ethyl, propyl, or phenyl substituents. Closed cages can be formed bearing —X—CH═CH—R″ or —X—C≡C—R″ in possible combination with the mentioned alkyl and aryl substituents in the corners of the cages, while open cages might still have unreacted alkoxy groups remaining or can carry silanol groups from hydrolysis reaction thereof.

The branched silicone resin can alternatively be a MQ resin in which at least 50 mole %, and preferably at least 70% or 85%, of the siloxane units present in the branched silicone resin are selected from Q units and M units as herein defined. The molar ratio of M units to Q units is preferably in the range 0.4:1 to 1.5:1. Such resins can be produced by the condensation of a monoalkoxysilane such as trimethylmethoxysilane with a tetraalkoxysilane such as tetraethoxysilane. The groups of the formula —X—CH═CH—R″ (I) or —X—C≡C—R″ (II) can be introduced by incorporating them in a monoalkoxysilane or by reacting a trialkoxysilane as described above with the monoalkoxysilane and tetraalkoxysilane to introduce some T units of the formula R″—CH═CH—X—SiO_{3/2} into the MQ resin.

For many uses it is preferred that the branched silicone resin contains Si-bonded hydroxyl or hydrolysable groups, so that the grafted product can be further crosslinked in the presence of water by hydrolysis of the hydrolysable groups if required and siloxane condensation. Preferred hydrolysable groups are Si-bonded alkoxy groups, particularly Si—OR groups in which R represents an alkyl group having 1 to 4 carbon atoms. Such Si—OH or Si—OR groups can be present in the branched silicone resin at 1 to 100 Si—OH or hydrolysable groups per 100 siloxane units, preferably 5 to 50 Si—OR groups per 100 siloxane units.

The branched silicone resin is preferably present in the composition at 1 to 30% by weight based on the polyolefin during the grafting reaction.

In a preferred embodiment, the composition contains, in addition to the polyorganosiloxane and polyolefin, an unsaturated silane, having at least one hydrolysable group bonded to Si, or a hydrolysate thereof, characterized in that the silane has the formula R″—CH═CH—Z (I) or R″—C≡C—Z (II) in which Z represents an electron-withdrawing moiety substituted by a —SiRₐR′₍₃₋ₐ₎ group wherein R represents a hydrolysable group; R′ represents a hydrocarbyl group having 1 to 6 carbon atoms; a has a value in the range 1 to 3 inclusive; and R″ represents hydrogen or a group having an electron withdrawing effect or any other activation effect with respect to the —CH═CH— or —C≡C— bond. Such unsaturated silanes are described in WO2010/000478.

The polyolefin can for example be a polymer of an olefin having 2 to 10 carbon atoms, particularly of an alpha olefin of the formula CH₂═CHQ where Q is a hydrogen or a linear or branched alkyl group having 1 to 8 carbon atoms, and is in general a polymer containing at least 50 mole % units of an olefin having 2 to 10 carbon atoms.

The polyolefin can for example be a polymer of ethene (ethylene), propene (propylene), butene or 2-methyl-propene-1 (isobutylene), hexene, heptene, octene, styrene. Propylene and ethylene polymers are an important class of polymers, particularly polypropylene and polyethylene. Polypropylene is a commodity polymer which is broadly available and of low cost. It has low density and is easily processed and versatile. Most commercially available polypropylene is isotactic polypropylene, but the process of the invention is applicable to atactic and syndiotactic polypropylene as well as to isotactic polypropylene. Isotactic polypropylene is prepared for example by polymerization of propene using a Ziegler-Natta catalyst or a metallocene catalyst. The invention can provide a crosslinked polypropylene of improved properties from commodity polypropylene. The polyethylene can for example be high density polyethylene of density 0.955 to 0.97 g/cm³, medium density polyethylene (MDPE) of density 0.935 to 0.955 g/cm³ or low density polyethylene (LDPE) of density 0.918 to 0.935 g/cm³ including ultra low density polyethylene, high pressure low density polyethylene and low pressure low density polyethylene, or microporous polyethylene. The polyethylene can for example be produced using a Ziegler-Natta catalyst, a chromium catalyst or a metallocene catalyst. The polyolefin can alternatively be a polymer of a diene, such as a diene having 4 to 18 carbon atoms and at least one terminal double bond, for example butadiene or isoprene. The polyolefin can be a copolymer or terpolymer, for example a copolymer of propylene with ethylene or a copolymer of propylene or ethylene with an alpha-olefin having 4 to 18 carbon atoms, or of ethylene or propylene with an acrylic monomer such as acrylic acid, methacrylic acid, acrylonitrile, methacrylonitrile or an ester of acrylic or methacrylic acid and an alkyl or substituted alkyl group having 1 to 16 carbon atoms, for example ethyl acrylate, methyl acrylate or butyl acrylate, or a copolymer with vinyl acetate. The polyolefin can be a terpolymer for example a propylene ethylene diene terpolymer. The polyolefin can be heterophasic, for example a propylene ethylene block copolymer.

Grafting of the branched silicone resin to the polyolefin generally requires means capable of generating free radical sites in the polyolefin. The means for generating free radical sites in the polyolefin preferably comprises a compound capable of generating free radicals, and thus capable of generating free radical sites in the polyolefin. Other means include applying shear, heat or irradiation such as electron beam radiation. The high temperature and high shear rate generated by a melt extrusion process can generate free radical sites in the polyolefin.

The compound capable of generating free radical sites in the polyolefin is preferably an organic peroxide, although other free radical initiators such as azo compounds can be used. Preferably the radical formed by the decomposition of the free-radical initiator is an oxygen-based free radical. It is more preferable to use hydroperoxides, carboxylic peroxyesters, peroxyketals, dialkyl peroxides and diacyl peroxides, ketone peroxides, diaryl peroxides, aryl-alkyl peroxides, peroxydi carbonates, peroxyacids, acyl alkyl sulfonyl peroxides and monoperoxydicarbonates. Examples of preferred peroxides include dicumyl peroxide, 2,5-dimethyl-2,5-di-(tert-butylperoxy)hexane, di-tert-butyl peroxide, 2,5-dimethyl-2,5-di-(tert-butylperoxy)hexyne-3,3,6,9-triethyl-3,6,9-trimethyl-1,4,7-triperoxonane, benzoyl peroxide, 2,4-dichlorobenzoyl peroxide, tert-butyl peroxyacetate, tert-butyl peroxybenzoate, tert-amylperoxy-2-ethylhexyl carbonate, tert-butylperoxy-3,5,5-trimethylhexanoate, 2,2-di(tert-butylperoxy)butane, tert-butylperoxy isopropyl carbonate, tert-buylperoxy-2-ethylhexyl carbonate, butyl 4,4-di(tert-buylperoxy)valerate, di-tert-amyl peroxide, tert-butyl peroxy pivalate, tert-butyl-peroxy-2-ethyl hexanoate, di(tertbutylperoxy)cyclohexane, tertbutylperoxy-3,5,5-trimethylhexanoate, di(tertbutylperoxyisopropyl)benzene, cumene hydroperoxide, tert-butyl peroctoate, methyl ethyl ketone peroxide, tert-butyl α-cumyl peroxide, 2,5-dimethyl-2,5-di(peroxybenzoate)hexyne-3,1,3- or 1,4-bis(t-butylperoxyisopropyl)benzene, lauroyl peroxide, tert-butyl peracetate, and tert-butyl perbenzoate. Examples of azo compounds are azobisisobutyronitrile and dimethylazodiisobutyrate. The above radical initiators can be used alone or in combination of at least two of them.

The temperature at which the polyolefin and the branched silicone resin are reacted in the presence of the compound capable of generating free radical sites in the polyolefin is generally above 120° C., usually above 140° C., and is sufficiently high to melt the polyolefin and to decompose the free radical initiator. For polypropylene and polyethylene, a temperature in the range 170° C. to 220° C. is usually preferred. The peroxide or other compound capable of generating free radical sites in the polyolefin preferably has a decomposition temperature in a range between 120-220° C., most preferably between 160-190° C.

The compound capable of generating free radical sites in the polyolefin is generally present in an amount of at least 0.01% by weight of the total composition and can be present in an amount of up to 5 or 10%. An organic peroxide, for example, is preferably present at 0.01 to 2% by weight based on the polyolefin during the grafting reaction. Most preferably, the organic peroxide is present at 0.01% to 0.5% by weight of the total composition.

The means for generating free radical sites in the polyolefin can alternatively be an electron beam. If electron beam is used, there is no need for a compound such as a peroxide capable of generating free radicals. The polyolefin is irradiated with an electron beam having an energy of at least 5 MeV in the presence of the unsaturated silane (I) or (II). Preferably, the accelerating potential or energy of the electron beam is between 5 MeV and 100 MeV, more preferably from 10 to 25 MeV. The power of the electron beam generator is preferably from 50 to 500 kW, more preferably from 120 to 250 kW. The radiation dose to which the polyolefin/grafting agent mixture is subjected is preferably from 0.5 to 10 Mrad. A mixture of polyolefin and the branched silicone resin can be deposited onto a continuously moving conveyor such as an endless belt, which passes under an electron beam generator which irradiates the mixture. The conveyor speed is adjusted in order to achieve the desired irradiation dose.

Polyethylene and polymers consisting mainly of ethylene units do not usually degrade when free radical sites are generated in the polyethylene. Efficient grafting can be achieved with a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond whether or not X contains an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″.

If the polyolefin comprises at least 50% by weight units of an olefin having 3 to 8 carbon atoms, for example when polypropylene constitutes the major part of the thermoplastic resin, β-scission may occur if X does not contain an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″. In this case, for example if —X—CH═CH—R″ is an acryloxyalkyl group, grafting reaction is preferably carried out in the presence of a co-agent which inhibits polymer degradation by beta scission.

The co-agent which inhibits polymer degradation is preferably a compound containing an aromatic ring conjugated with an olefinic —C═C— or acetylenic —C≡C— unsaturated bond. By an aromatic ring we mean any cyclic moiety which is unsaturated and which shows some aromatic character or π-bonding. The aromatic ring can be a carbocyclic ring such as a benzene or cyclopentadiene ring or a heterocyclic ring such as a furan, thiophene, pyrrole or pyridine ring, and can be a single ring or a fused ring system such as a naphthalene, quinoline or indole moiety. Most preferably the co-agent is a vinyl or acetylenic aromatic compound such as styrene, alpha-methylstyrene, beta-methyl styrene, vinyltoluene, vinyl-pyridine, 2,4-biphenyl-4-methyl-1-pentene, phenylacetylene, 2,4-di(3-isopropylphenyl)-4-methyl-1-pentene, 2,4-di(4-isopropylphenyl)-4-methyl-1-pentene, 2,4-di(3-methylphenyl)-4-methyl-1-pentene, 2,4-di(4-methylphenyl)-4-methyl-1-pentene, and may contain more than one vinyl group, for example divinylbenzene, o-, m- or p-diisopropenylbenzene, 1,2,4- or 1,3,5-triisopropenylbenzene, 5-isopropyl-m-diisopropenylbenzene, 2-isopropyl-p-diisopropenylbenzene, and may contain more than one aromatic ring, for example trans- and cis-stilbene, 1,1-diphenylethylene, or 1,2-diphenylacetylene, diphenyl imidazole, diphenylfulvene, 1,4-diphenyl-1,3-butadiene, 1,6-diphenyl-1,3,5-hexatriene, dicinnamalacetone, phenylindenone. The co-agent can alternatively be a furan derivative such as 2-vinylfuran. A preferred co-agent is styrene.

The co-agent which inhibits polymer degradation can alternatively be a compound containing an olefinic —C═C— or acetylenic —C≡C— conjugated with an olefinic —C═C— or acetylenic —C≡C— unsaturated bond. For example a sorbate ester, or a 2,4-pentadienoates, or a cyclic derivative thereof. A preferred co agent is ethylsorbate of the formula:

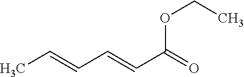

The co-agent which inhibits polymer degradation can alternatively be a multi-functional acrylate, such as e.g., trimethylolpropane triacrylate, pentaerythritol tetracrylate, pentaerythriol triacrylate, diethyleneglycol diacrylate, dipropylenglycol diacrylate or ethylene glycol dimethacrylate, or lauryl and stearylacrylates.

The co-agent which inhibits polymer degradation is preferably added with the organopolysiloxane resin and the compound such as a peroxide capable of generating free radical sites in the polyolefin. The co-agent, for example a vinyl aromatic compound such as styrene, is preferably present at 0.1 to 15.0% by weight of the total composition.

If the branched silicone resin contains at least one group of the formula —X—CH═CH—R″ (I) or —X—C≡C—R″ (II), in which X represents a divalent organic linkage containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, efficient grafting can be achieved without substantial β-scission even if the polyolefin comprises at least 50% by weight units of an olefin having 3 to 8 carbon atoms.

The product of the grafting reaction between the polyolefin and the branched silicone resin is a grafted polymer in which the polyolefin is reinforced by the branched silicone resin. All or only some of the branched silicone resin may be grafted to the polyolefin. Even if only some of the branched silicone resin is grafted to the polyolefin, the resulting composite is reinforced compared to a composite comprising a polyolefin and a branched silicone resin not capable of undergoing the grafting reaction.

If the branched silicone resin contains hydrolysable groups, for example silyl-alkoxy groups, these can react in the presence of moisture with hydroxyl groups present on the surface of many fillers and substrates, for example of minerals and natural products. The moisture can be ambient moisture or a hydrated salt can be added. Grafting of the polyolefin with a branched silicone resin according to the invention can be used to improve compatibility of the polyolefin with fillers. The polyolefin grafted with hydrolysable groups can be used as a coupling agent improving filler/polymer adhesion; for example polypropylene grafted according to the invention can be used as a coupling agent for unmodified polypropylene in filled compositions. The polyolefin grafted with hydrolysable groups can be used as an adhesion promoter or adhesion interlayer improving the adhesion of a low polarity polymer such as polypropylene to surfaces. The hydrolysable groups can also react with each other in the presence of moisture to form Si—O—Si linkages between polymer chains.

The hydrolysable groups, for example silyl-alkoxy groups, react with each other in the presence of moisture to form Si—O—Si linkages between polymer chains even at ambient temperature, without catalyst, but the reaction proceeds much more rapidly in the presence of a siloxane condensation catalyst. Thus the grafted polymer can be crosslinked by exposure to moisture in the presence of a silanol condensation catalyst. The grafted polymer can be foamed by adding a blowing agent, moisture and condensation catalyst. Any suitable condensation catalyst may be utilised. These include protic acids, Lewis acids, organic and inorganic bases, transition metal compounds, metal salts and organometallic complexes.

Preferred catalysts include organic tin compounds, particularly organotin salts and especially diorganotin dicarboxylate compounds such as dibutyltin dilaurate, dioctyltin dilaurate, dimethyltin dibutyrate, dibutyltin dimethoxide, dibutyltin diacetate, dimethyltin bisneodecanoate, dibutyltin dibenzoate, dimethyltin dineodeconoate or dibutyltin dioctoate. Alternative organic tin catalysts include triethyltin tartrate, stannous octoate, tin oleate, tin naphthate, butyltintri-2-ethylhexoate, tin butyrate, carbomethoxyphenyl tin trisuberate and isobutyltin triceroate. Organic compounds, particularly carboxylates, of other metals such as lead, antimony, iron, cadmium, barium, manganese, zinc, chromium, cobalt, nickel, aluminium, gallium or germanium can alternatively be used.

The condensation catalyst can alternatively be a compound of a transition metal selected from titanium, zirconium and hafnium, for example titanium alkoxides, otherwise known as titanate esters of the general formula Ti[OR⁵]₄ and/or zirconate esters Zr[OR⁵]₄ where each R⁵ may be the same or different and represents a monovalent, primary, secondary or tertiary aliphatic hydrocarbon group which may be linear or branched containing from 1 to 10 carbon atoms. Preferred examples of R⁵ include isopropyl, tertiary butyl and a branched secondary alkyl group such as 2,4-dimethyl-3-pentyl. Alternatively, the titanate may be chelated with any suitable chelating agent such as acetylacetone or methyl or ethyl acetoacetate, for example diisopropyl bis(acetylacetonyl)titanate or diisopropyl bis(ethylacetoacetyl)titanate.

The condensation catalyst can alternatively be a protonic acid catalyst or a Lewis acid catalyst. Examples of suitable protonic acid catalysts include carboxylic acids such as acetic acid and sulphonic acids, particularly aryl sulphonic acids such as dodecylbenzenesulphonic acid. A “Lewis acid” is any substance that will take up an electron pair to form a covalent bond, for example, boron trifluoride, boron trifluoride monoethylamine complex, boron trifluoride methanol complex, FeCl₃, AlCl₃, ZnCl₂, ZnBr₂ or catalysts of formula MR⁴_{f}X_{g} where M is B, Al, Ga, In or TI, each R⁴ is independently the same or different and represents a monovalent aromatic hydrocarbon radical having from 6 to 14 carbon atoms, such monovalent aromatic hydrocarbon radicals preferably having at least one electron-withdrawing element or group such as —CF₃, —NO₂ or —CN, or substituted with at least two halogen atoms; X is a halogen atom; f is 1, 2, or 3; and g is 0, 1 or 2; with the proviso that f+g=3. One example of such a catalyst is B(C₆F₅)₃.

An example of a base catalyst is an amine or a quaternary ammonium compound such as tetramethylammonium hydroxide, or an aminosilane. Amine catalysts such as laurylamine can be used alone or can be used in conjunction with another catalyst such as a tin carboxylate or organotin carboxylate.

The siloxane condensation catalyst is typically used at 0.005 to 1.0 by weight of the total composition. For example a diorganotin dicarboxylate is preferably used at 0.01 to 0.1% by weight of the total composition.

The compositions of the invention can contain one or more organic or inorganic fillers and/or fibers. According to one aspect of the invention grafting of the polyolefin can be used to improve compatibility of the polyolefin with fillers and fibrous reinforcements. Improved compatibility of a polyolefin such as polypropylene with fillers or fibers can give filled polymer compositions having improved properties whether or not the grafted polyolefin is subsequently crosslinked optionally using a silanol condensation catalyst. Such improved properties can for example be improved physical properties derived from reinforcing fillers or fibres, or other properties derived from the filler such as improved coloration by pigments. The fillers and/or fibres can conveniently be mixed into the polyolefin with the branched silicone resin and the organic peroxide during the grafting reaction, or can be mixed with the grafted polymer subsequently.

When forming a filled polymer composition, the grafted polymer can be the only polymer in the composition or can be used as a coupling agent in a filled polymer composition also comprising a low polarity polymer such as an unmodified polyolefin. The grafted polymer can thus be from 1 or 10% by weight up to 100% of the polymer content of the filled composition. Moisture and optionally silanol condensation catalyst can be added to the composition to promote bonding between filler and grafted polymer. Preferably the grafted polymer can be from 2% up to 10% of the total weight of the filled polymer composition.

Examples of mineral fillers or pigments which can be incorporated in the grafted polymer include titanium dioxide, aluminium trihydroxide, magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminium oxide, antimony pentoxide, antimony trioxide, beryllium oxide, chromium oxide, iron oxide, lithopone, boric acid or a borate salt such as zinc borate, barium metaborate or aluminium borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, bentonite, clay, talc, anthracite, apatite, attapulgite, boron nitride, cristobalite, diatomaceous earth, dolomite, ferrite, feldspar, graphite, calcined kaolin, molybdenum disulfide, perlite, pumice, pyrophyllite, sepiolite, zinc stannate, zinc sulfide or wollastonite. Examples of fibres include natural fibres such as wood flour, wood fibers, cotton fibres, cellulosic fibres or agricultural fibres such as wheat straw, hemp, flax, kenaf, kapok, jute, ramie, sisal, henequen, corn fibre or coir, or nut shells or rice hulls, or synthetic fibres such as polyester fibres, aramid fibers, nylon fibers, or glass fibers. Examples of organic fillers include lignin, starch or cellulose and cellulose-containing products, or plastic microspheres of polytetrafluoroethylene or polyethylene. The filler can be a solid organic pigment such as those incorporating azo, indigoid, triphenylmethane, anthraquinone, hydroquinone or xanthine dyes.

The concentration of filler or pigment in such filled compositions can vary widely; for example the filler or pigment can form from 1 or 2% up to 70% by weight of the total composition.

The grafted polyolefin of the invention can also be used to improve the compatibility of a low polarity polymer such as polypropylene with a polar polymer. The composition comprising the low polarity polymer, polar polymer and grafted polyolefin can be filled and/or fibre-reinforced or unfilled.

The grafted polyolefin of the present invention can also be used for increasing the surface energy of polyolefins for further improving the coupling or adhesion of polyolefin based materials with higher surface energy polymers typically used in inks, paints, adhesives and coatings, e.g., epoxy, polyurethanes, acrylics and silicones.

When forming a crosslinked polyolefin article by grafting of a branched silicone resin containing hydrolysable groups and crosslinking by moisture, the grafted polymer is preferably shaped into an article and subsequently crosslinked by moisture. In one preferred procedure, a silanol condensation catalyst can be dissolved in the water used to crosslink the grafted polymer. For example an article shaped from grafted polyolefin can be cured by water containing a carboxylic acid catalyst such as acetic acid, or containing any other common catalyst capable of accelerating the hydrolysis and condensation reactions of alkoxy-silyl groups. However, crosslinking may also take place in absence of such catalyst.

Alternatively or additionally, the silanol condensation catalyst can be incorporated into the grafted polymer before the grafted polymer is shaped into an article. The shaped article can subsequently be crosslinked by moisture. The catalyst can be mixed with the polyolefin before, during or after the grafting reaction.

In one preferred procedure, the polyolefin, the branched silicone resin containing hydrolysable groups, the compound capable of generating free radical sites in the polyolefin and the vinyl aromatic co-agent if required are mixed together at above 120° C. in a twin screw extruder to graft the branched silicone resin to the polymer, and the resulting grafted polymer is mixed with the silanol condensation catalyst in a subsequent mixing step. Mixing with the catalyst can for example be carried out continuously in an extruder, which can be an extruder adapted to knead or compound the materials passing through it such as a twin screw extruder as described above or can be a more simple extruder such as a single screw extruder. Since the grafted polymer is heated in such a second extruder to a temperature above the melting point of the polyolefin, the grafting reaction may continue in the second extruder.

In an alternative preferred procedure, the silanol condensation catalyst can be premixed with part of the polyolefin and the branched silicone resin can be premixed with a different portion of the polyolefin, and the two premixes can be contacted, optionally with further polyolefin, in the mixer or extruder used to carry out the grafting reaction. Since the preferred condensation catalysts such as diorganotin dicarboxylates are liquids, it may be preferred to absorb them on a microporous polyolefin before mixing with the bulk of the polypropylene or other polyolefin in an extruder.

For many uses the grafted polymer composition preferably contains at least one antioxidant. Examples of suitable antioxidants include tris(2,4-di-tert-butylphenyl)phosphite sold commercially under the trade mark Ciba Irgafos®168, tetrakis[methylene-3-(3,5-di-tert-butyl-4-hydroxyphenyl-propionate)]methane processing stabilizer sold commercially under the trade mark Ciba Irganox®1010 and 1.3.5-trimethyl-2.4.6-tris(3.5-di-tert-butyl-4-hydroxy benzyl)benzene sold commercially under the trade mark Ciba Irganox®1330. It may also be desired that the crosslinked polymer contains a stabiliser against ultraviolet radiation and light radiation, for example a hindered amine light stabiliser such as a 4-substituted-1,2,2,6,6-pentamethylpiperidine, for example those sold under the trade marks Tinuvin® 770, Tinuvin® 622, Uvasil® 299, Chimassorb® 944 and Chimassorb® 119. The antioxidant and/or hindered amine light stabiliser can conveniently be incorporated in the polyolefin either with the unsaturated silane and the organic peroxide during the grafting reaction or with the silanol condensation catalyst if this is added to the grafted polymer in a separate subsequent step.

The grafted polymer composition of the invention can also contain other additives such as dyes or processing aids.

The reinforced polyolefin compositions produced by grafting according to the invention can be used in a wide variety of products. The reinforced polymer can be blow moulded or rotomoulded to form bottles, cans or other liquid containers, liquid feeding parts, air ducting parts, tanks, including fuel tanks, corrugated bellows, covers, cases, tubes, pipes, pipe connectors or transport trunks. The reinforced polymer can be blow extruded to form pipes, corrugated pipes, sheets, fibers, plates, coatings, film, including shrink wrap film, profiles, flooring, tubes, conduits or sleeves or extruded onto wire or cable as an electrical insulation layer. The reinforced polymer can be injection moulded to form tube and pipe connectors, packaging, gaskets and panels. The reinforced polymer can also be foamed or thermoformed. If the branched silicone resin contains hydrolysable groups, the shaped article can in each case be crosslinked by exposure to moisture in the presence of a silanol condensation catalyst.

Reinforced polyolefin articles produced according to the invention have improved mechanical strength, heat resistance, chemical and oil resistance, creep resistance, flame retardancy, scratch resistance and/or environmental stress cracking resistance compared to articles formed from the same polyolefin without grafting or crosslinking.

The invention provides a composition comprising a thermoplastic polyolefin and a polysiloxane, characterized in that the polysiloxane is a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond and/or containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C≡C— bond.
Preferably at least 50 mole % of the siloxane units present in the branched silicone resin are T units as herein defined.
Preferably, 0.1 to 100 mole % of the siloxane T units present in the branched silicone resin are of the formula R″-CH═CH—X—SiO3/2.
Preferably, at least 50 mole % of the siloxane units present in the branched silicone resin are selected from Q units and M units as herein defined.
Preferably, the unsaturated groups of the formula —X—CH═CH—R″ are present as T units of the formula R″—CH═CH—X—SiO3/2.
Preferably, the branched silicone resin contains hydrolysable Si—OR groups, in which R represents an alkyl group having 1 to 4 carbon atoms.
Preferably, the branched silicone resin containing at least one group of the formula —X—CH═CH—R″ (I) or —X—C≡C—R″ (II) is present at 1 to 30% by weight of the total composition.
Preferably, X represents a divalent organic linkage having an electron withdrawing effect with respect to the —CH═CH— or —C≡C— bond.
Preferably, the group of the formula —X—CH═CH—R″ (I) is an acryloxyalkyl group.
Preferably, the polyolefin comprises at least 50% by weight units of an olefin having 3 to 8 carbon atoms.
Preferably, the composition contains a co-agent which inhibits polyolefin degradation by beta scission in the presence of a compound capable of generating free radical sites in the polyolefin.
Preferably, the said co-agent is a vinyl aromatic compound, preferably styrene, or a sorbate ester, preferably ethyl sorbate.
Preferably, the co-agent is present at 0.1 to 15.0% by weight of the total composition.
Preferably, the group of the formula —X—CH═CH—R″ (I) or —X—C≡C—R″ (II) contains an aromatic ring or a further olefinic double bond or acetylenic unsaturation, the aromatic ring or the further olefinic double bond or acetylenic unsaturation being conjugated with the olefinic —C═C— or acetylenic —C≡C— unsaturation of the group —X—CH═CH—R″ (I) or —X—C≡C—R″ (II).
Preferably, the polyolefin comprises at least 50% by weight units of an alpha-olefin having 3 to 8 carbon atoms.
Preferably, the group —X—CH═CH—R″ (I) or —X—C≡C—R″ (II) has the formula CH2=CH—C6H4-A- (III) or CH≡C—C6H4-A- (IV), wherein A represents a direct bond or a divalent organic group having 1 to 12 carbon atoms optionally containing a divalent heteroatom linking group chosen from —O—, —S— and —NH—.
Preferably, the group —X—CH═CH—R″ (I) has the formula R2-CH═CH—CH═CH—X—, where R2 represents hydrogen or a hydrocarbyl group having 1 to 12 carbon atoms.
Preferably, the group —X—CH═CH—R″ (I) is a sorbyloxyalkyl group.
Preferably, the composition contains an organic peroxide compound capable of generating free radical sites in the polyolefin, the organic peroxide being present at 0.01 to 2% by weight of the total composition.

The invention provides a process for grafting silicone onto a polyolefin, comprising reacting the polyolefin with a silicon compound containing an unsaturated group in the presence of means capable of generating free radical sites in the polyolefin, characterized in that the silicon compound is a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond and/or containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C≡C— bond.
1. The invention provides the use of a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond and/or containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C≡C— bond, in grafting silicone moieties to a polyolefin to reinforce the polyolefin.
2. The invention provides the use of a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond, X being bonded to the branched silicone resin by a C—Si bond, and R″ represents hydrogen or a group having an electron withdrawing effect or any other activation effect with respect to the —CH═CH— or —C≡C— bond, in grafting silicone moieties to a polyolefin, to give enhanced grafting compared to an unsaturated silicone not containing a —X—CH═CH—R″ or —X—C≡C—R″ group.
3. The invention provides the use of a branched silicone resin containing at least one group of the formula —X—CH═CH—R″ (I) or —X—C≡C—R″ (II), in which X represents a divalent organic linkage containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C≡C— bond, in grafting silicone moieties to a polyolefin with less degradation of the polymer compared to grafting with an unsaturated silicon compound not containing an aromatic ring.

The invention is illustrated by the following Examples.

### Raw Materials

The thermoplastic organic resins used were:
PP=Isotactic polypropylene homopolymer supplied as Borealis® HB 205 TF (melt flow index MFR 1 g/10 min at 230° C./2.16 kg measured according to ISO 1133);
PE=High density polyethylene BASELL® Lupolen 5031L (melt flow index MFR ranging from 5.8 to 7.3 g/10 min at 190° C./2.16 kg measured according to ISO 1133);
Porous PP, microporous polypropylene supplied by Membrana as Accurel® XP100, MFR (2.16 kg/230° C.) 2.1 g/10 min (method ISO1133), and melting temperature (DSC) 156° C.
Porous PE, microporous polyethylene supplied by Membrana as Accurel® XP200, MFR (2.16 kg/190° C.) 1.8 g/10 min (method ISO1133), and melting temperature (DSC) 119° C.

The peroxide used is:
DHBP was 2,5-dimethyl-2,5-di-(tert-butylperoxy)hexaneperoxide supplied as Arkema Luperox® 101 peroxide;

Anti-oxidants used were:
Irgafos 168 was tris-(2,4-di-tert-butylphenyl)phosphite antioxidant supplied by Ciba as Irgafos®168.
Irganox 1010 was tetrakis[methylene-3-(3,5-di-tert-butyl-4-hydroxyphenyl-propionate)]methane phenolic antioxidant supplied by Ciba as Irganox®1010.

The condensation catalyst used was:
1% acetic acid diluted into water for curing molded or injected specimens underwater;
Dioctyltindilaurate (DOTDL) supplied by ABCR® (ref. AB106609) diluted into Naphthenic processing oil Nyflex® 222B sold by Nynas with a viscosity of 104 cSt (40° C., method ASTM D445) and specific gravity 0.892 g/cm3 (method ASTM D4052) for compounding into the composite material.

The co-agent used for inhibiting polymer degradation was
Ethyl sorbate≧98% supplied by Sigma-Aldrich Reagent Plus® (ref. 177687).

The branched silicone resins that were used in Examples 1 to 4 were prepared as follows:

### Resin 1: DMe²₁₅T^{Me}₄₀T^{Ph}₄₅Y^{Acryl}₁₀

0.3 mol of dimethyldimethoxysilane, 0.8 mol of methyltrimethoxysillane, 0.90 mol of phenyltrimethoxysilane, 0.2 mol of 3-acryloxypropyltrimethoxysilane and 0.1 g of trifluoromethanesulforic acid were added to a flask. 6.3 mol of water was added to the flask at RT (Room Temperature) under stirring. Then the mixture was refluxed for 2 hours. Formed methanol was removed under atmospheric pressure until the reaction mixture reached at 80° C. About 100 g of toluene was added to the flask and a remaining methanol and excess waster were removed by azeotropic dehydration. After cooling to RT, 0.08 g of ammonia water was added for the neutralization. The reaction mixture was heated again and azeotropic dehydration continued until 100° C. After cooling, the reaction mixture was filtrated and the toluene and remaining low volatile were removed at 90° C. under vacuum. A yield of 236 g of a resin was obtained. The empirical formula of the resin was determined by analysis and the weight average molecular weight Mw was measured and are recorded in Table 1.

### Resin 2: T^{Me}₁₀T^{Acryl}₁(OMe)

3.11 mol of methyltrimethoxysillane, 0.31 mol of 3-acryloxypropyltrimethoxysilane and 0.25 g of trifluoromethanesulforic acid were added to a flask. A mixture of 2.95 mol of water and 51.3 g of methanol was added to the flask at RT under stirring. Then the mixture was refluxed for 2 hours. Formed methanol was removed under atmospheric pressure until the reaction mixture reached at 70° C. Then 2.83 g of calcium carbonate was added for neutralization and removal of methanol continued until the reaction mixture reached 80° C. Remaining low volatiles were stripped off under vacuum. A yield of 332 g of a resin was obtained. The empirical formula and Mw are shown in Table 1.

### Resin 3: M^{Me3}₇Q₁₀T^{Acryl}_{1.7}

0.53 mol of 1,1,1,3,3,3-hexamethyl disiloxane, 3.0 g of hydrochloric acid, 90 g of water and 45 g of ethanol were added to a flask. A mixture of 1.5 mol of tetraethoxysilane, 0.26 mol of 3-acryloxypropyltrimethoxysilane was added to the flask at RT under stirring. Then the reaction mixture was heated and stirred at 50° C. for 2 hours. After cooling, 200 g of toluene was loaded and 2.94 g of ammonia water was added for neutralization. Formed methanol, ethanol and excess water were removed by azeotropic dehydration. Deposited neutralization salt was removed by a filtration after cooling. Toluene and remaining low volatiles were stripped off under vacuum. A yield of 219 g of a resin was obtained. The empirical formula and Mw are shown in Table 1

TABLE 1

| | | | | | | | | | T(Acryl) | MW |
|---|---|---|---|---|---|---|---|---|---|---|
| | M(Me3) | Q | D(Me2) | T(Me) | T(Ph) | T(Acryl) | OMe | OH | Mole % | g/mole |
| Resin | 0 | 0 | 15 | 40 | 44 | 10 | 4 | 0 | 8.8% | 2200 |
| Example 1 | | | | | | | | | | |
| Resin | 0 | 0 | 0 | 97 | 0 | 10 | 134 | 0 | 4.1% | 730 |
| Example 2 | | | | | | | | | | |
| | | | | | | | OMe + | | | |
| | M(Me3) | Q | D(Me2) | T(Me) | T(Ph) | T(Acryl) | OEt | OH | | |
| Resin | 6.8 | 10 | 0 | 0 | 0 | 1.7 | 1.7 | 3.7 | 7.1% | 2100 |
| Example 3 | | | | | | | | | | |

Resins 1 to 3 were then used in Examples 1 to 4, which compositions are described below.

### EXAMPLE 1

10 parts by weight porous PP pellets were tumbled with 1.6 part by weight ethylsorbate and 0.2 part by weight DHBP until the liquid reagents were absorbed by the polypropylene to form a peroxide masterbatch.

3 parts by weight D^{Me2}₁₅T^{Me}₄₀T^{Ph}₄₅T^{Acryl}₁₀ solid resin were then added to the peroxide masterbatch to form an organopolysiloxane resin masterbatch.

100 parts by weight Borealis® HB 205 TF polypropylene pellets were loaded in a Brabender® Plastograph 350E mixer equipped with roller blades, in which compounding was carried out. Mixer filling ratio was 0.7. Rotation speed was 50 rpm, and the temperature of the chamber was maintained at 190° C. Torque and temperature of the melt were monitored for controlling the reactive processing of the ingredients. The PP was loaded in three portions allowing 1 minute fusion/mixing after each addition. The organopolysiloxane resin masterbatch was then added and mixed for 4 minutes to start the grafting reaction. The antioxidants were then added and mixed for a further 1 minute during which grafting continued. The melt was then dropped from the mixer and cooled down to ambient temperature. The resulting grafted polypropylene was molded into 2 mm thick sheet on an Agila® PE30 press at 210° C. for 5 minutes before cooling down to ambient temperature at 15° C./min with further pressing.

Samples of the 2 mm sheet were cured at 90° C. for 24 hours in a water bath containing 1% acetic acid as a catalyst.

### EXAMPLES 2 TO 4

In Example 2, Example 1 was repeated with Resin 1 (D^{Me2}₁₅T^{Me}₄₀T^{Ph}₄₅T^{Acryl}₁₀), being replaced by Resin 2 (T^{Me}₁₀T^{Acryl}₁(OMe)).

In Example 3, Example 1 was repeated with Resin 1 being replaced by Resin 3 (M^{Me3}₇Q₁₀T^{Acryl}_{1.7})

In Example 4, Example 1 was repeated with PP resin and porous PP carrier of Example 1 being replaced by PE resin and PE porous carrier. Since PE resin does not suffer degradation upon the melt extrusion process in presence of peroxide, the ethyl sorbate co-agent was also omitted in Example 4.

### COMPARATIVE EXAMPLES C1 TO C4

In Comparative Examples C1 to C3, Examples 1 to 3 were repeated replacing the acryloxy-functional polysiloxane resin with an equivalent polysiloxane resin that was not containing acryloxy-groups, and by omitting the addition of peroxide and ethylsorbate co-agent. The empirical formulae of the resins used in Comparative Examples C1 to C3 (Comparative Resins C1 to C3) is shown in Table 2

In Comparative Example C4, Example 4 was repeated by replacing the acryloxy-functional polysiloxane resin of Examples 1 and 4 with an equivalent polysiloxane resin that was not containing acryloxy-groups (Resin C1), and by omitting the addition of peroxide.

The torque during compounding and the elastic shear modulus G′ of the crosslinked polypropylene after 24 hours curing were measured and recorded in Table 2. The processing torque is the measure of the torque in Newton*meter (N.m) applied by the motor of the Plastograph 350E mixer to maintain the mixing speed of 50 rpm. The torque value reported is the plateau level at the end of the mixing step. The lower the torque, the lower the polymer viscosity. The torque level at the end of mixing stage is therefore an image of polymer degradation during mixing.

Mechanical performances of each compound were evaluated by tensile testing according to ISO-527 on specimens described in Table 2. Results obtained are shown in Table 2.

Comparing Examples 1, 2 and 3 with Comparative Example C1, C2 and C3, respectively, we can observe that tensile strength at break and tensile modulus were all higher in case acryloxy-functional silicone resins of the examples (Resin 1, Resin 2 and Resin 3, respectively) were grafted onto PP resin in comparison to specimens were silicone resins were not grafted.

Comparing Examples 4 with Comparative Example C4, we can observe that tensile modulus was higher in case acryloxy-functional silicone resins of example 4 (Resin 1) was grafted onto PE resin in comparison to specimens were silicone resins was not grafted (Comparative Example C4).

In conclusions, in the series of PP compounds of Table 2, despite lower torques and lower G′ after curing for specimens of Examples 1, 2, 3 in comparison to Comparative Examples C1, C2 and C3, toughness of the material were higher for the series of examples that were effectively grafted with acryloxy-functional silicone resins than toughness of material where PP resin and silicone resins were simply blended.

TABLE 2

| | Example | Example | Example | Example | Comparative | Comparative | Comparative | Comparative |
|---|---|---|---|---|---|---|---|---|
| | 1 | 2 | 3 | 4 | Example C1 | Example C2 | Example C3 | Example C4 |
| PP resin | 100 | 100 | 100 | | 100 | 100 | 100 | |
| PE resin | | | | 100 | | | | 100 |
| Porous PP resin | 10 | 10 | 10 | | 10 | 10 | 10 | |
| Porous PE resin | | | | 10 | | | | 10 |
| DHBP peroxide | 0.2 | 0.2 | 0.2 | 0.1 | | | | |
| Irganox ® 1010 antioxidant | 0.5 | 0.5 | 0.5 | 0.5 | 0.5 | 0.5 | 0.5 | 0.5 |
| Irgafos ® 168 antioxidant | 0.5 | 0.5 | 0.5 | 0.5 | 0.5 | 0.5 | 0.5 | 0.5 |
| Ethylsorbate | 1.6 | 1.6 | 1.6 | | | | | |
| Resin 1 D^{Me2}₁₅T^{Me}₄₀T^{Ph}₄₅T^{Acryl}₁₀ | 3.0 | | | 3.0 | | | | |
| Comparative Resin C1 | | | | | 3.0 | | | 3.0 |
| D^{Me2}₁₅T^{Me}₄₀T^{Ph}₄₅ | | | | | | | | |
| Resin 2 T^{Me}₁₀T^{Acryl}₁(OMe) | | 1.5 | | | | | | |
| Comparative Resin C2 | | | | | | 1.5 | | |
| T^{Me}₁₀ (OMe) | | | | | | | | |
| Resin 3 M^{Me3}₇Q₁₀T^{Acryl}_{1.7} | | | 2.5 | | | | | |
| Comparative Resin C3 | | | | | | | 2.5 | |
| M^{Me3}₇Q₁₀ | | | | | | | | |
| Torque (Nm) | 45 | 42 | 43 | 75 | 77 | 77 | 77 | 58 |
| Tensile Strength at break (MPa) | 29 | 30 | 27 | 5 | 21 | 20.5 | 20.5 | 5 |
| Tensile Modulus (MPa) | 1893 | 1550 | 1746 | 1441 | 1772 | 1540 | 1646 | 1380 |
| Elongation at break (%) | 28 | 20 | 28 | 61 | 26 | 33 | 24 | 60 |

1. A composition comprising a thermoplastic polyolefin and a polysiloxane, wherein the polysiloxane is a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond and/or containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C≡C— bond.

2. A composition according to claim 1, wherein at least 50 mole % of the siloxane units present in the branched silicone resin are T units as herein defined.

3. A composition according to claim 1, wherein 0.1 to 100 mole % of the siloxane T units present in the branched silicone resin are of the formula R″—CH═CH—X—SiO3/2.

4. A composition according to claim 1, wherein at least 50 mole % of the siloxane units present in the branched silicone resin are selected from Q units and M units as herein defined.

5. A composition according to claim 4, wherein the unsaturated groups of the formula —X—CH═CH—R″ are present as T units of the formula R″-CH═CH—X—SiO3/2.

6. A composition according to claim 1, wherein the branched silicone resin contains hydrolysable Si—OR groups, in which R represents an alkyl group having 1 to 4 carbon atoms.

7. A composition according to claim 1, wherein the branched silicone resin containing at least one group of the formula —X—CH═CH—R″ (I) or —X—C≡C—R″ (II) is present at 1 to 30% by weight of the total composition.

8. A composition according to claim 1, wherein X represents a divalent organic linkage having an electron withdrawing effect with respect to the —CH═CH— or —C≡C— bond.

9. A composition according to claim 8, wherein the group of the formula —X—CH═CH—R″ (I) is an acryloxyalkyl group.

10. A composition according to claim 9, wherein the polyolefin comprises at least 50% by weight units of an olefin having 3 to 8 carbon atoms

11. A composition according to claim 10, further comprising a co-agent which inhibits polyolefin degradation by beta scission in the presence of a compound capable of generating free radical sites in the polyolefin.

12. A composition according to claim 11, wherein the co-agent is a vinyl aromatic compound, or a sorbate ester.

13. A composition according to claim 11, wherein the co-agent is present at 0.1 to 15.0% by weight of the total composition.

14. A composition according to claim 1, wherein the group of the formula —X—CH═CH—R″ (I) or —X—C≡C—R″ (II) contains an aromatic ring or a further olefinic double bond or acetylenic unsaturation, the aromatic ring or the further olefinic double bond or acetylenic unsaturation being conjugated with the olefinic —C═C— or acetylenic unsaturation of the group —X—CH═CH—R″ (I) or —X—C≡C—R″ (II).

15. A composition according to claim 14, wherein the polyolefin comprises at least 50% by weight units of an alpha-olefin having 3 to 8 carbon atoms.

16. A composition according to claim 14 wherein the group —X—CH═CH—R″ (I) or —X—C≡C—R″ (II) has the formula CH₂═CH—C₆H₄-A- (III) or CH≡C—C₆H₄-A- (IV), wherein A represents a direct bond or a divalent organic group having 1 to 12 carbon atoms optionally containing a divalent heteroatom linking group chosen from —O—, —S— and —NH—.

17. A composition according to claim 14, wherein the group —X—CH═CH—R″ (I) has the formula R2-CH═CH—CH═CH—X—, where R2 represents hydrogen or a hydrocarbyl group having 1 to 12 carbon atoms.

18. A composition according to claim 17, wherein the group
—X—CH═CH—R″ (I) is a sorbyloxyalkyl group.

19. A composition according to claim 1, further comprising an organic peroxide compound capable of generating free radical sites in the polyolefin, the organic peroxide being present at 0.01 to 2% by weight of the total composition.

20. A process for grafting silicone onto a polyolefin, comprising reacting the polyolefin with a silicon compound containing an unsaturated group in the presence of means capable of generating free radical sites in the polyolefin, wherein the silicon compound is a branched silicone resin containing at least one group of the formula —X—CH═CH—R″ (I) or —X—C≡C—R″ (II), in which X represents a divalent organic linkage having an electron withdrawing effect with respect to the —CH═CH— or —C≡C— bond and/or containing an aromatic ring or a further olefinic double bond or acetylenic unsaturation, the aromatic ring or the further olefinic double bond or acetylenic unsaturation being conjugated with the olefinic unsaturation of —X—CH═CH—R″ or with the acetylenic unsaturation of —X—C≡C—R″, X being bonded to the branched silicone resin by a C—Si bond, and R″ represents hydrogen or a group having an electron withdrawing effect or any other activation effect with respect to the —CH═CH— or —C≡C— bond.

21-23. (canceled)
